(19) United States
(12) Patent Application Publication
(10) Pub. No.: US 2020/0059583 A1
(43) Pub. Date: Feb. 20, 2020

(54) CAMERA MODULE

(71) Applicant: MITSUMI ELECTRIC CO., LTD., Tama-shi, Tokyo (JP)

(72) Inventor: Kazuya TAMURA, Tokyo (JP)

(73) Assignee: MITSUMI ELECTRIC CO., LTD., Tama-shi, Tokyo (JP)

(21) Appl. No.: 16/096,617

(22) PCT Filed: Apr. 18, 2017
(86) PCT No.: PCT/JP2017/015574

§ 371 Date: Oct. 25, 2018

(30) Foreign Application Priority Data
Apr. 28, 2016 (JP) 2016-090301

(51) Int. Cl. H04N 5/225; G02B 7/02; G03B 17/55

(52) U.S. Cl. CPC H04N 5/2257; G03B 17/55; G02B 7/02; H04N 5/2253

(57) ABSTRACT

A camera module which captures images of a subject includes a heat source, a case in which the heat source is hermitically sealed, a heat conducting plate which is received inside the case and which is in thermal contact with the heat source, a heat conducting bracket, provided outside the case, for mounting the camera module to a mounted body, and a heat transfer member which transfers heat between the heat conducting plate and the heat conducting bracket.

### TECHNICAL FIELD

The present invention relates to a camera module and, more particularly, to an on-vehicle camera module which is mounted in a compartment of an automobile or the like.

### BACKGROUND ART

An on-vehicle camera module of the type described is mounted in a compartment, such as at a sun visor of the automobile, a B pillar, a rear glass, a flip down or the like. The on-vehicle camera module includes a lens unit and a sensor board unit for mounting an image sensor which images a subject via the lens unit.

In such an on-vehicle camera module, the lens unit and the sensor board unit are hermetically sealed by a resin molded case (housing). Accordingly, heat generated in the sensor board unit is stuffed in the case (housing). That is, the sensor board unit serves as a heat source.

Specially, in the summer season, a temperature in the compartment of the automobile becomes a high temperature. As a result, in the on-vehicle camera module disposed in the compartment, a temperature in the case (housing) becomes a high temperature higher than the temperature in the compartment due to the heat generated by the above-mentioned heat source. For each of devices (including optical parts) constituting the on-vehicle camera module, an upper limit use temperature (a guarantee temperature) is set. Therefore, the temperature in the case may possibly rises to a level above the upper limit use temperature (the guarantee temperature).

Accordingly, it is necessary to efficiently dissipate the heat generated by the heat source to the outside of the case (housing) of the on-vehicle camera module. Techniques provided with such a heat-dissipation measure have heretofore been proposed.

For example, Patent Document 1 discloses a solid-state imaging apparatus in which heat dissipation and electromagnetic shielding can efficiently be performed. The solid-state imaging apparatus (on-vehicle camera) disclosed in Patent Document 1 has a first case, a lens unit, a lens bracket, an imaging module, a shielding section, a power supply module, and a second case. The first case and the second case are combined with each other to contain the lens unit, the lens bracket, the imaging module, the shielding section, and the power supply module. As a material of the first case and the second case, a resin or a metal such as aluminum is used. A metal filler may be mixed in the first case and the second case to improve thermal conductivity. The shielding section is a heat dissipation plate which has electric conductivity and heat conductivity and which is placed between the imaging module and the power supply module so as to cover the power supply module. The shielding section is sandwiched between the imaging module and the power supply module. When the on-vehicle camera is assembled, the shielding section is thermally in contact with the first case and the second case so that heat is dissipated to the outside of the on-vehicle camera through the first case and the second case.

### PRIOR ART

### Patent Document(s)

Patent Document 1: WO 2012/137267 A1

### SUMMARY OF THE INVENTION

### Problem(s) to be Solved by the Invention

The above-mentioned Patent Document 1 has the problems described below.

The configuration of the on-vehicle camera disclosed in Patent Document 1 requires a part of the shielding section made of the heat dissipation plate to be exposed to the outside of the case when the first case and the second case are made of the material of resin. With this configuration, however, it is difficult to efficiently dissipate the heat in the case (housing) to the outside.

On the other hand, in Patent Document 1, the thermal conductivity is improved by using, as the material of the first case and the second case, a metal such as aluminum or by mixing a metal filler in the first case and the second case. By adopting such configurations, it is possible to efficiently dissipate the heat in the case (housing) to the outside. With such configurations, however, the cost of the material of the case (housing) itself inevitably becomes expensive.

More in detail, it is assumed that a material, such as aluminum, having a good heat conductivity is used as the material of the case (housing). In order to manufacture such as a case (housing) made of aluminum, a casting process, a cutting and polishing process for a mount surface, and a surface treatment process are essential. Therefore, the case (housing) made of aluminum itself becomes expensive and, as a result, the on-vehicle becomes expensive.

It is also conceivable that the case (housing) is manufactured by using an inexpensive metal material (e.g. iron) having a good heat conductivity, other than aluminum. However, if it is tried to dissipate the heat in the case (housing) to the outside of the case (housing) directly through the case (housing), another problem arises. That is, since a person may touch the case (housing) in order to operate the on-vehicle camera, the person may possibly suffer a burn or the like due to the case (housing) having a high temperature.

It is therefore an object of the present invention to provide a camera module which is capable of efficiently dissipating heat in a case (housing) to the outside without passing through the case (housing) and of using an inexpensive material for the case (housing).

Other objects of the present invention will become clear as the description proceeds.

In the description of the present invention, the words of upward, an upper end, an upper part, and an upper surface indicate a subject side in an optical axis direction in a camera module according to the present invention while the words of downward, a lower end, a lower part, and a lower surface indicate an image sensor side in the optical axis direction in the camera module according to the present invention.

### Means to Solve the Problem(s)

The gist of an exemplary aspect of the present invention is as follows: A camera module is a camera module for imaging a subject. The camera module includes a heat source; a case for hermetically sealing the heat source; a heat conducting plate which is received in an interior of the case and which comes in thermal contact with the heat source; a heat conducting bracket which is provided at an outside of the case and which is for mounting the camera module to a mounted body; and a heat transfer member for carrying out heat transfer between the heat conducting plate and the heat conducting bracket.

### Effect(s) of the Invention

According to the present invention, it is possible to provide a camera module which is capable of efficiently dissipating heat in a case (housing) to the outside without passing through the case (housing) and of using an inexpensive material for the case (housing).

### BRIEF DESCRIPTION OF THE DRAWINGS

FIG. 1 is an exterior perspective view of a camera module according to an exemplary embodiment of the present invention.

FIG. 2 is an exterior perspective view showing a state where a heat conducting bracket is removed from the on-vehicle camera module in FIG. 1.

FIG. 3 is an exploded perspective view of the on-vehicle camera module in FIG. 2.

FIG. 4 is a perspective view showing a state where a case (housing) is deleted from the on-vehicle camera module illustrated in FIG. 1.

FIG. 5 is a view showing locations in an automobile where the on-vehicle camera module illustrated in FIG. 1 is mounted.

FIG. 6 is a perspective view showing a heat transfer path in the on-vehicle camera module illustrated in FIG. 1 with a part thereof being exploded.

FIG. 7 is a perspective view of the heat transfer path illustrated in FIG. 6.

FIG. 8 is a side view of the heat transfer path illustrated in FIG. 6.

### EMBODIMENT FOR CARRYING OUT THE INVENTION

### Example Embodiment

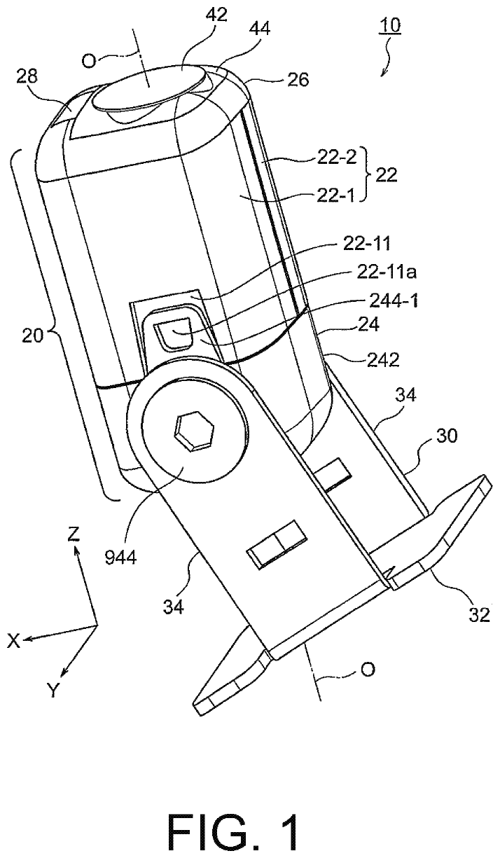

Referring to FIGS. 1 through 5, description will proceed to a configuration of a camera module 10 according to an exemplary embodiment of the present invention. As will later be described, the camera module 10 illustrated in the figures comprises an on-vehicle camera module which is installed in a compartment and which images a subject (not shown).

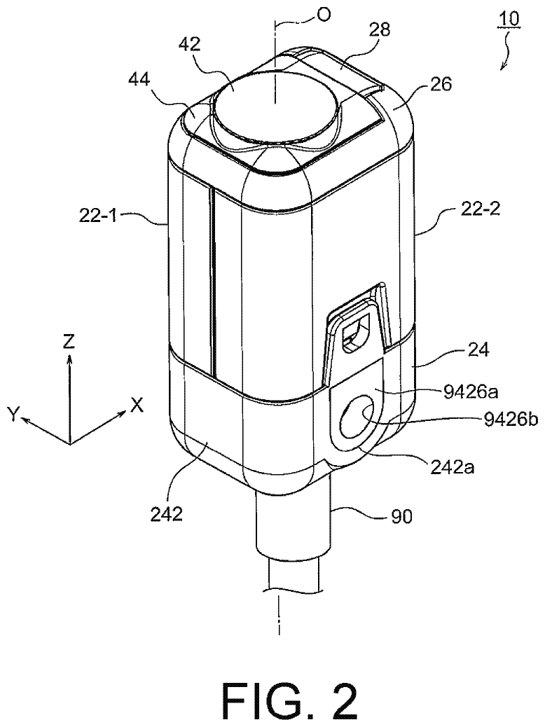

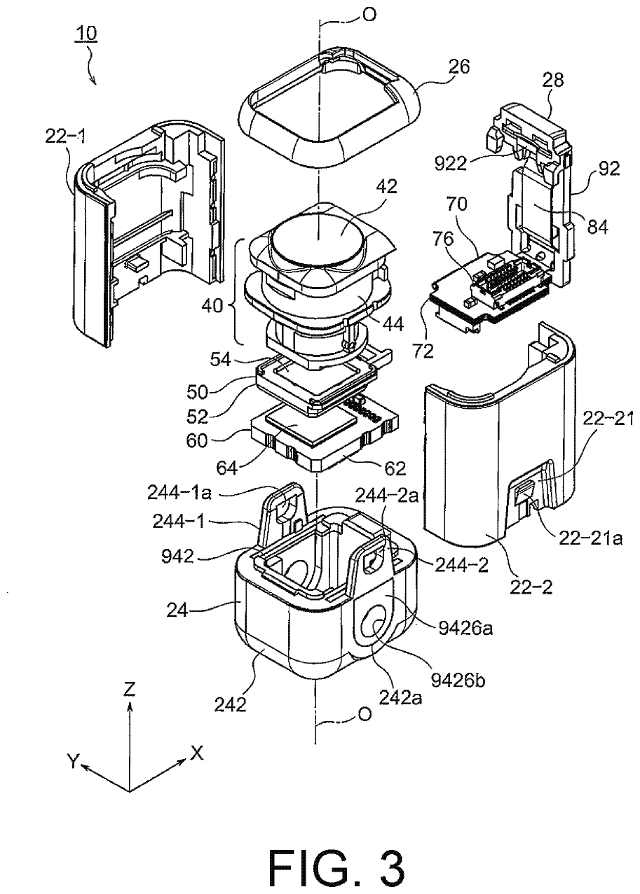

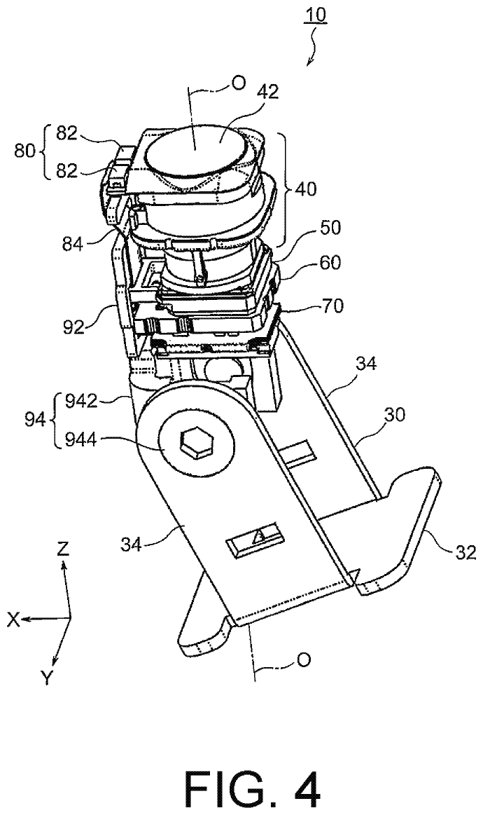

FIG. 1 is an exterior perspective view of an on-vehicle camera module 10. FIG. 2 is an exterior perspective view showing a state where a heat conducting bracket 30 is removed from the on-vehicle camera module 10 in FIG. 1. FIG. 3 is an exploded perspective view of the on-vehicle camera module 10 in FIG. 2. FIG. 4 is perspective view showing a state where a case (housing) 20 is deleted from the on-vehicle camera module 10 illustrated in FIG. 1.

As shown in FIGS. 1 to 4, an orthogonal coordinate system (X, Y, Z) is used herein. In the state illustrated in FIGS. 1 to 4, in the orthogonal coordinate system (X, Y, Z), the direction of an X-axis is defined as a fore-and-aft direction (depth direction), the direction of a Y-axis as a left-and-right direction (width direction), and the direction of a Z-axis as an up-and-down direction (height direction). In the example shown in FIGS. 1 to 4, the up-and-down direction Z is a direction of an optical axis O of a lens. In the example illustrated in the figure, an upward direction of the up-and-down direction Z is a direction along which a subject (not shown) is present. In this example embodiment, the direction of the Y-axis (left-and-right direction) may also be called a first direction while the direction of the X-axis (fore-and-aft direction) may also be called a second direction.

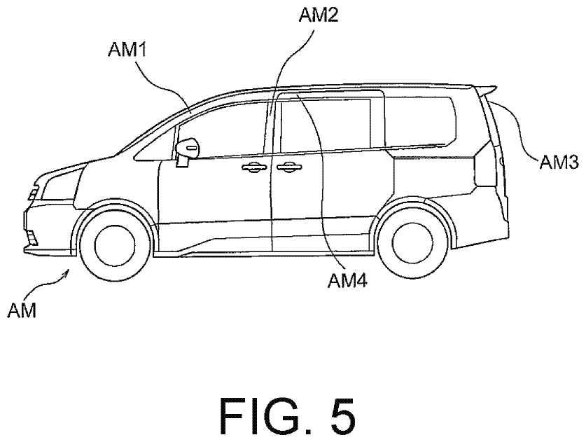

FIG. 5 is a view showing locations in an automobile AM where the on-vehicle camera module 10 illustrated in FIG. 1 is to be mounted. As shown in FIG. 5, the on-vehicle camera module 10 is mounted in the compartment at, as a mounted body, a sun visor AM1 of the automobile AM, a B pillar AM2, a rear glass AM3, a flip down AM4, or the like.

As shown in FIG. 1, the on-vehicle camera module 10 comprises heat sources which will be described later, the case 20 for hermetically sealing the heat sources, and a heat conducting bracket 30. The heat conducting bracket 30 is provided at the outside of the case 20 and is for mounting the on-vehicle camera module 10 to the above-mentioned mounted body of the automobile AM.

In the example being illustrated, the heat conducting bracket 30 is made of iron. However, a material of the heat conducting bracket 30 is not limited to iron and may be a material having good heat conduction.

As shown in FIGS. 3 and 4, the on-vehicle camera module 10 comprises a lens unit 40, a filter unit 50, a sensor board unit 60, and a power supply board unit 70 which are received in the case 20.

The sensor board unit 60 comprises a sensor board 62, an image sensor 64 mounted on an upper surface of the sensor board 62, and a plug connector (not shown) mounted on a lower surface of the sensor board 62. The image sensor 64 images the subject through the lens unit 40 and the filter unit 50.

In the sensor board unit 60, not only the image sensor 64 and the plug connector but also chip capacitors, chip resistors, a flash ROM (read only memory), a crystal oscillator, and so on are packaged on the sensor board 62 as packaging parts. The sensor board unit 60 serves as one of the above-mentioned heat sources.

The power supply board unit 70 comprises a power supply board 72 and a receptacle connector 76 mounted on an upper surface of the power supply board 72.

In the power supply board unit 70, not only the receptacle connector 76 but also chip capacitors, chip resistors, a flash ROM (read only memory), a crystal oscillator, and so on are packaged on the power supply board 72 as packaging parts.

The plug connector in the sensor board unit 60 and the receptacle connector 76 in the power supply board unit 70 are engaged with each other. A combination of the plug connector and the receptacle connector 76 is called an inter-board connector. Accordingly, the sensor board unit 60 and the power supply board unit 70 are engaged with each other via the inter-board connector.

A combination of the sensor board unit 60 and the power supply board unit 70 is called a board unit (60, 70).

The filter unit 50 is provided between the lens unit 40 and the sensor board unit 60.

The filter unit 50 comprises a base member 52 mounted on the sensor board 62 and an infrared cutting filter (IRCF) 54 mounted on an upper surface of the base member 52. The infrared cutting filter (IRCF) 54 and the above-mentioned image sensor 64 are disposed opposite to each other with a space left therebetween. In the example being illustrated, the infrared cutting filter (IRCF) 54 comprises a filter for cutting a wavelength of 960 nm or more.

The lens unit 40 comprises a group of lenses (which will later be described) and a lens barrel 44 for holding the group of lenses. The lens barrel 44 also serves to shield the group of the lenses.

In the example being illustrated, the group of lenses comprises four lenses. Specifically, the group of lenses comprises three plastic lenses (not shown) and one glass lens 42. The glass lens 35 may also be called an upper lens because it is provided at an uppermost part in the group of lenses. The three plastic lenses are arranged in the lens barrel 44. The glass lens 42 is disposed at an upper part in the lens barrel 44.

The image sensor 64 images a subject image focused by the above-mentioned group of lenses in the lens unit 40 and converts the image into electric signals. For example, the image sensor 64 comprises a CCD (charge coupled device) type image sensor, a CMOS (complementary metal oxide semiconductor) type image sensor, or the like.

The illustrated on-vehicle camera module 10 is a camera module which is capable of taking an image even during nighttime. For this purpose, as shown in FIG. 4, the on-vehicle camera module 10 comprises an infrared emission portion 80 comprising two infrared LEDs (light emission diodes) 82 which are disposed in the vicinity of the lens unit 40. The infrared emission portion 80 serves as another of the above-mentioned heat sources.

The two infrared LEDs 82 are connected to the power supply board 72 of the power supply board unit 70 through a flexible printed circuit board (FPC) 84.

Although the infrared emission portion 80 comprises the two infrared LEDs 82 in the example being illustrated, the number of the infrared LEDs is not limited to two and may be one or three or more.

A combination of the lens unit 40, the filter unit 50, and the sensor board unit 60 serves as a camera portion (40, 50, 60) for capturing an image.

Accordingly, by irradiating the subject with infrared rays emitted from the infrared emission portion 80, the camera portion (40, 50, 60) of the on-vehicle camera module 10 can image the subject even during the nighttime.

As shown in FIGS. 1 and 3, the case 20 comprises an upper case 22 disposed on an upper side in the up-and-down direction Z, a lower case 24 disposed on a lower side in the up-and-down direction Z, a retainer 26 for preventing water from entering into the interior of the lens unit 40, and an emission portion cover 28 for covering the infrared emission portion 80.

In the example being illustrated, each of the upper case 22 and the lower case 24 is made of polycarbonate. However, the material of each of the upper case 22 and the lower case 24 is not limited to polycarbonate, and other heat-resistant resins or a low heat-resistant material (e.g., paper, wood or the like) subjected to surface treatment by a heat-resistant material may be used. Alternatively, as the material of each of the upper case 22 and the lower case 24, an inexpensive metal material (e.g. Iron) having good thermal conductivity, other than aluminum, may be used.

As shown in FIG. 3, the upper case 22 comprises a first upper divided case 22-1 and a second upper divided case 22-2 and is dividable into two in the left-and-right direction Y. In the example being illustrated, the first upper divided case 22-1 is disposed on a right side in the left-and-right direction Y while the second upper divided case 22-2 is disposed on a left side in the left-and-right direction. By combining the first upper divided case 22-1 and the second upper divided case 22-2, the upper case 22 of a generally-quadrilateral tubular shape which is substantially chamfered at corners is formed as shown in FIG. 1.

The retainer 26 is mounted to an upper end portion of the upper case 22. The retainer 26 has a cutout part to which the emission portion cover 28 can be inserted. In the example being illustrated, the emission portion cover 28 is made of a plastic material for cutting a wavelength of 850 nm or less. Accordingly, from the infrared emission portion 80, infrared rays having the wavelength of 850 nm or more are emitted toward the subject.

Therefore, in the on-vehicle camera module 10 illustrated in the figure, a wavelength range in which imaging in a dark place is possible becomes 850 nm to 960 nm.

A combination of the upper case 22, the retainer 26, and the emission portion cover 28 is called a first case (22, 26, 28).

As shown in FIG. 1, in the upper case 22, the upper divided case 22-1 has a first hollow portion 22-11 at a lower end part thereof. The first hollow portion 22-11 has a first engagement projection (insertion claw) 22-11a which projects outward.

Likewise, as shown in FIG. 2, in the upper case 22, the second upper divided case 22-2 has a second hollow portion 22-21 at a lower end part thereof. The second hollow portion 22-21 has a second engagement projection (insertion claw) 22-21a which projects to the outside.

On the other hand, the lower case 24 is mounted to a lower end part of the upper case 22 in the manner which will later be described.

More in detail, the lower case 24 comprises a lower reception portion 242 of a generally-quadrilateral tubular shape which is substantially chamfered at corners and which has a circular bottom opening (not shown) at a bottom part, a first arm portion 244-1 extending upward from an upper end and right end part of the lower reception portion 242, and a second arm portion 244-2 extending upward from an upper end and left end part of the lower reception portion 242. The first arm portion 244-1 has a first engagement hole (fitting hole) 244-1a at an upper end part thereof while the second arm portion 244-2 has a second engagement hole (fitting hole) 244-2a at an upper end part thereof.

Accordingly, after the upper case 22 is formed by combining the first upper divided case 22-1 and the second upper divided case 22-2, when the lower case 24 is put toward the upper case 22 to cover the upper case, the first and the second arm portions 244-1 and 244-2 at first bend outward and thereafter return to original states (positions). As a result, the first and the second engagement projections (insertion claws) 22-11a and 22-21a are engaged with (fitted to) the first and the second engagement holes (fitting holes) 244-1a and 244-2a, respectively. Consequently, it is possible to prevent the lower case 24 from being disconnected from the upper case 22. The lower case 24 is also called a second case.

Thus, the first case (22, 26, 28) and the second case 24 are mechanically connected to each other by means of snap fitting.

Although the snap fitting is used as mechanical connection between the first case (22, 26, 28) and the second case 24 in this example embodiment, it is a matter of course that the mechanical connection between the first case (22, 26, 28) and the second case 24 is not limited thereto.

As shown in FIG. 2, a cable 90 is soldered to a lower surface of the power supply board 72 and passes through the above-mentioned bottom opening of the lower reception portion 242 in the lower case 24 to extend downward.

In the example embodiment, as shown in FIGS. 3 and 4, the on-vehicle camera module 10 comprises a heat conducting plate 92 which is received in an interior of the case 20 and which comes in thermal contact with the infrared emission portion 80 and the sensor board unit 60 as the above-mentioned heat sources, and a heat transfer member 94 for transferring heat between the heat conducting plate 92 and the heat conducting bracket 30.

As shown in FIG. 4, the heat transfer member 94 comprises a heat transfer plate 942 which is received in the interior of the case 20 and which comes in thermal contact with the heat conducting plate 92, and a heat conducting fastening member 944 for fastening the heat transfer plate 942 and the heat conducting bracket 30.

As shown in FIG. 3, the first case (22, 26, 28) receives the lens unit 40, the filter unit 50, the sensor board unit 60, the power supply board unit 70, the infrared emission portion 80 comprising the infrared LEDs 82, and the heat conducting plate 92. On the other hand, the second case 24 receives the heat transfer plate 942.

The heat conducting plate 92 is thermally coupled to the sensor board unit 60 through heat conductive grease (not shown). The heat conducting plate 92 has a tip portion 922 which comes into contact with a bottom surface of the infrared emission portion 80 comprising the infrared LEDs 82.

In the example being illustrated, as each of the heat conducting plate 92 and the heat transfer plate 942, aluminum having a thermal conductivity of 230 W/mK is used. Each of the heat conducting plate 92 and the heat transfer plate 942 is formed by a metal plate.

However, the material of each of the conduction plate 92 and the heat transfer plate 942 is not limited to aluminum. It is preferable to use a material having a thermal conductivity of not less than 100 W/mK.

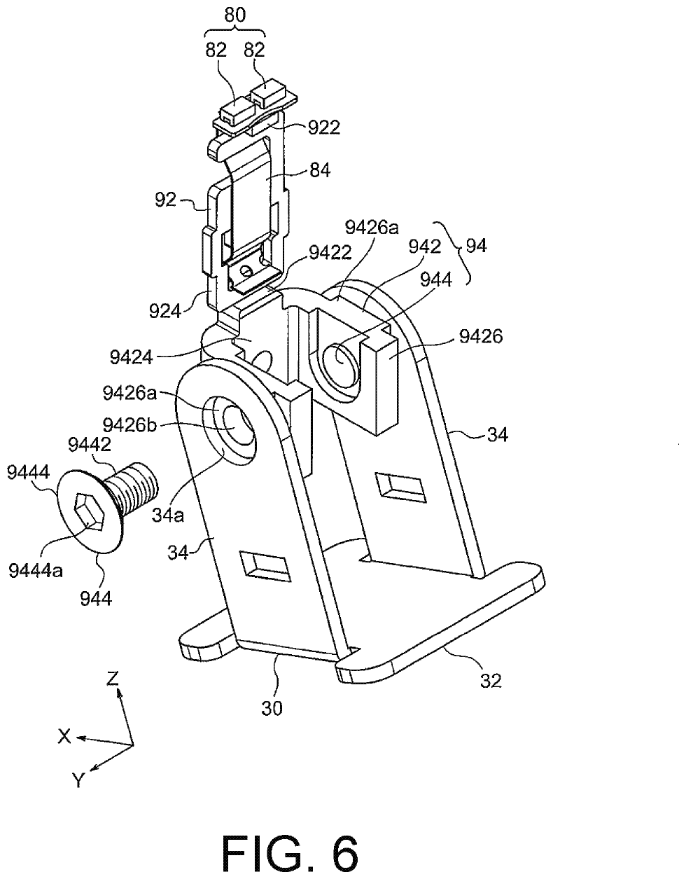

Next referring to FIGS. 6 to 8, description will proceed to a heat transfer path for transferring heat generated by the infrared emission portion 80 as the heat source to the outside of the case 20 to dissipate the heat without passing through the case 20.

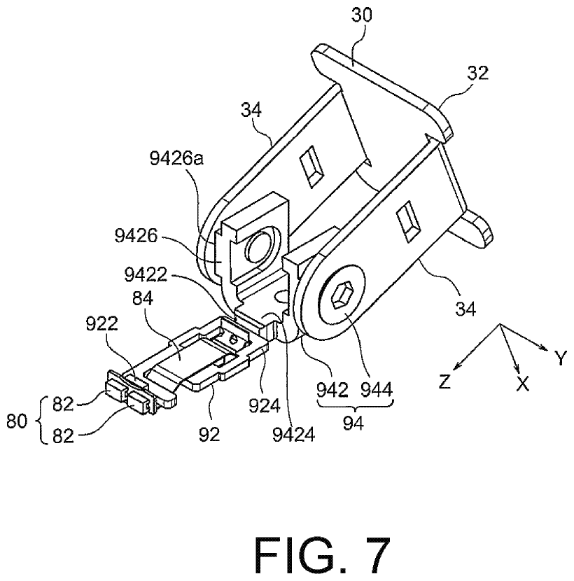

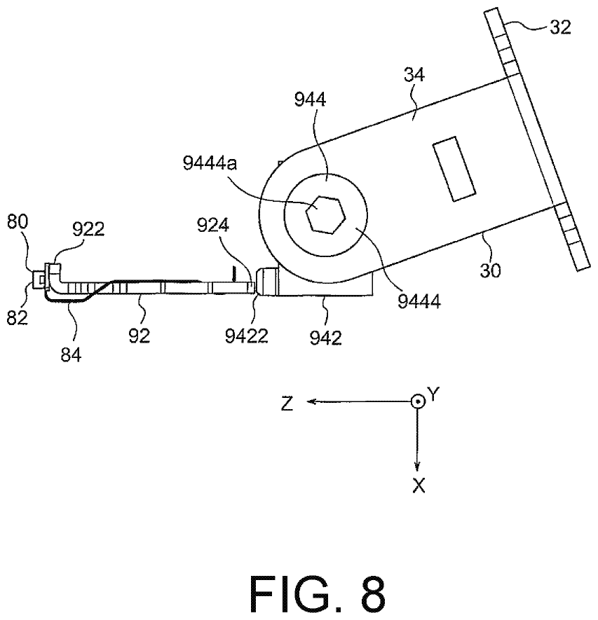

FIG. 6 is a perspective view showing the heat transfer path with a part thereof exploded. FIG. 7 is a perspective view of the heat transfer path and FIG. 8 is a side view of the heat transfer path.

As described above, the tip portion 922 of the heat conducting plate 92 is kept in contact with the bottom surface of the infrared emission portion 80 comprising the two infrared LEDs 82. The heat conducting plate 92 extends in the up-and-down direction Z. In the example being illustrated, the heat conducting plate 92 has a thickness of 1 mm. However, the heat conducting plate 92 may have any thickness not greater than 2 mm.

As is apparent from FIG. 6, the flexible printed circuit board (FPC) 84 is wired along the heat conducting plate 92 through an opening formed in the heat conducting plate 92.

The heat conducting plate 92 has a terminal end portion 924 which is kept in thermal contact with a tip portion 9422 of the heat transfer plate 942. Although it is preferable that the terminal end portion 924 of the heat conducting plate 92 and the tip portion 9422 of the heat transfer plate 942 are kept in contact with each other, a little gap may exist therebetween. In this event, the gap is preferably 0.2 mm or less. Heat conductive grease may be applied to the gap.

The heat transfer plate 942 comprises a plate part 9424 which extends in the up-and-down direction Z and a pair of arm portions 9426 which extend backward from end parts of the plate part 9424 in the left-and-right direction Y, and has a substantially U-shape. Each arm portion 9426 has a projection portion 9426a which projects outward in the left-and-right direction Y.

As shown in FIGS. 2 and 3, the projection portions 9426a are inserted into side opening portions 242a formed in the lower reception portion 242 of the lower case (second case) 24 and are exposed from the side opening portions 242a.

The pair of projection portions 9426a have cylindrical holes 9426b provided with female threads.

The above-mentioned heat conducting fastening member 944 comprises a pair of heat conducting bolts to be screwed into the pair of cylindrical holes 9426b. In detail, each heat conducting bolt 944 comprises a male screw portion 9442 to be screwed into the cylindrical hole 9426b, and a head portion 9444. The head portion 9444 has a hexagonal concave portion 9444a. Accordingly, when a driver with a hexagonal cylindrical head (tip) is inserted into the hexagonal concave portion 9444a and the driver is rotated, it is possible to screw the pair of heat conducting bolts 944 into the cylindrical holes 9426b of the pair of projection portions 9426a of the heat transfer plate 942.

In the example being illustrated, the heat conducting bolts 944 are made of iron. However, a material of the heat conducting bolts 944 are not limited to iron and may be any material having good heat conduction.

The heat conducting bracket 30 comprises a plate-shaped mounting portion 32 to be mounted to the mounted body, and a pair of arm portions 34 vertically extending from both end parts of the mounting portion 32 in the left-and-right direction Y substantially in the up-and-down direction Z.

By adhering a rear (bottom) surface of the mounting portion 32 to a surface of the mounted body using a double-sided adhesive tape, the heat conducting bracket 30 is mounted to the mounted body.

The pair of arm portions 34 are kept in contact with the projection portions 9426a of the pair of arm portions 9426 of the heat transfer plate 942 on inner walls of upper end parts thereof. In addition, the pair of arm portions 34 have through holes 34a which allow the male screw portions 9442 of the pair of heat conducting bolts 944 to pass therethrough. That is, the through hole 34a has a diameter which is larger than that of the male screw portion 9442 and which is smaller than an outer diameter of the head portion 9444.

Accordingly, when the pair of heat conducting bolts 944 are screwed into the cylindrical holes 9426b of the pair of the projection portions 9426a of the heat transfer plate 942, the head portions 9444 of the pair of heat conducting bolts 944 are slightly projected from outer walls of the pair of arm portions 34 of the heat conducting bracket 30.

According to the heat transfer path having the above-mentioned configuration, it is possible to efficiently transfer the heat generated by the infrared emission portion 80 to the heat conducting bracket 30 disposed on the outside of the case 20 through the heat conducting plate 92, the heat transfer plate 942, and the pair of heat conducting bolts 944. As a result, it is possible to efficiently dissipate the heat generated by the infrared emission portion 80 to the outside of the case 20 without passing through the case 20.

As described above, the sensor board unit 60 is thermally connected to the heat conducting plate 92 via the heat conductive grease. Accordingly, it is also possible to efficiently dissipate the heat generated by the sensor board unit 60 to the outside of the case 20 without passing through the case 20.

Now, description will proceed to effects of the example embodiment based on test results obtained by performing thermal analysis.

In the thermal analysis, it is tested whether or not each of devices and optical parts constituting the camera module 10 can be kept at a temperature not higher than the guarantee temperature thereof in a high-temperature environment where an ambient temperature (outside air temperature) is 70° C.

Herein, evaluation points are a surface temperature of the image sensor 64, a surface temperature of the lens unit 40 on the side of the image sensor 64, surface temperatures of the two infrared LEDs 82, and a temperature of the lens barrel 44 on the side of the LEDs 82.

It is assumed that the image sensor 64 has an upper limit use temperature of 105° C., the optical parts such as the lens unit 40 and the lens barrel 44 have an upper limit use temperature of 85° C., and each LED has an upper limit use temperature of 90° C.

Analyzed results were as follows. The surface temperature of the image sensor 64 was 96.1° C., the surface temperature of the lens unit 40 on the side of the image sensor 64 was 82.9° C., the surface temperatures of the two infrared LEDs 82 ware 82.8° C. and 82.6° C., and the temperature of the lens barrel 44 on the side of the LEDs 82 side was 77.8° C.

By the above-mentioned analyzed results, it has been confirmed that all of the temperatures at the evaluation points are kept at a temperature not higher than the upper limit use temperature and the devices and the optical parts constituting the camera module 10 are usable.

As is apparent from the foregoing description, according to the example embodiment of the present invention, it is possible to provide the camera module 10 which is capable of efficiently dissipating the heat generated by the heat sources 80 and 60 in the case (housing) 20 to the outside without passing through the case (housing) 20 and of using an inexpensive material for the case.

The description will proceed to exemplary aspects of the present invention.

According to an exemplary aspect of the present invention, there is provided a camera module (10) for imaging a subject, the camera module comprising a heat source (60, 80); a case (20) for hermetically sealing the heat source (60, 80); a heat conducting plate (92) which is received in an interior of the case (20) and which comes in thermal contact with the heat source (60, 80); a heat conducting bracket (30) which is provided at an outside of the case (20) and which is for mounting the camera module (10) to a mounted body (AM1 to AM4); and a heat transfer member (94) for carrying out heat transfer between the heat conducting plate (92) and the heat conducting bracket (30).

In the above-mentioned camera module (10), the heat transfer member (94) comprises a heat transfer plate (942) which is received in the interior of the case (20) and which comes in thermal contact with the heat conducting plate (92); and a heat conducting fastening member (944) for fastening the heat transfer plate (942) and the heat transfer bracket (30). In addition, the heat transfer plate (942) may have a hole (9426b) provided with a female thread and the heat conducting fastening member may comprise a heat conducting bolt (944) screwed into the hole (9426b). Preferably, each of the heat conducting plate (92) and the heat transfer plate (942) is made of a material having a thermal conductivity not less than 100 W/mK.

In addition, the above-mentioned camera module (10) may include a lens unit (40). In this case, the heat source comprises a sensor board unit (60) for mounting an image sensor (64) for imaging the subject via the lens unit (40). In this case, it is preferable that the heat conducting plate (92) is thermally coupled to the sensor board unit (60) through heat conductive grease. In addition, the heat source may further comprise an infrared LED (82) which is disposed in the vicinity of the lens unit (40). In this event, the heat conducting plate (92) has a tip portion (922) which comes into contact with a bottom surface of the infrared LED (82).

In the above-mentioned camera module (10), the case (20) comprises a first case (22, 26, 28) for receiving the lens unit (40), the sensor board unit (60), the infrared LED (82), and the heat conducting plate (92); and a second case (24) for receiving the heat transfer plate (942). In this case, it is preferable that the first case (22, 26, 28) and the second case (24) are mechanically connected to each other. The first case (22, 26, 28) and the second case (24) may be made of resin. In addition, mechanical connection between the first case (22, 26, 28) and the second case (24) is preferably carried out by means of snap fitting.

In the above-mentioned camera module (10), the above-mentioned mounted body may comprise an inner wall of an automobile (AM). In this event, the camera module comprises an on-vehicle camera module which is mounted in a comportment of the automobile (AM).

The above-mentioned reference symbols in parentheses are affixed in order to facilitate an understanding of the present invention and are mere examples. As a matter of course, the present invention is not limited thereto.

While the present invention has been described in the foregoing with reference to the exemplary embodiment thereof, the present invention is not limited to the embodiment. The configuration and the details of the present invention may be modified in various manners which could be understood by those skilled in the art within the scope of the present invention.

For example, the heat sources include the sensor board unit 60 and the infrared emission portion 80 in the above-mentioned exemplary embodiment. However, the present invention is applicable in a case where other parts act as the heat sources. In the above-mentioned exemplary embodiment, the heat conducting bolts 944 are used as the heat conducting fastening member by way of example. As a matter of course, however, other heat conducting fastening members may be used. In the above-mentioned exemplary embodiment, polycarbonate is used as the material of the upper case 22 and the lower case 24 constituting the case 20. However, it is a matter of course that the upper case and the lower case which are made of other materials may be used in the present invention. Furthermore, in the above-mentioned exemplary embodiment, a combination of the heat transfer plate 942 and the heat conducting fastening member 944 is used, by way of example, as the heat transfer member 94 for carrying out heat transfer between the heat conducting plate 92 and the heat conducting bracket 30. However, it is a matter of course that the heat transfer member of other configurations may be used in the present invention.

This application is based upon and claims the benefit of priority from Japanese patent application No. 2016-90301, filed on Apr. 28, 2016, the disclosure of which is incorporated herein in its entirety by reference.

### INDUSTRIAL APPLICABILITY

The camera module according to the present invention is not limited to the on-vehicle camera module and may be used as camera modules which are used in other fields.

### EXPLANATION OF REFERENCE SIGNS

10 camera module (on-vehicle camera module)
20 case (housing)
22 upper case (first case)
22-1 first upper divided case
22-11 first hollow portion
22-11a first engagement projection (insertion claw)
22-2 second upper divided case
22-21 second hollow portion
22-21a second engagement projection (insertion claw)
24 lower case (second case)
242 lower reception portion
242a side opening portion
244-1 first arm portion
244-1a first engagement hole (fitting hole)
244-2 second arm portion
244-2a second engagement hole (fitting hole)
26 retainer (first case)
28 emission portion cover (first case)
30 heat conducting bracket
32 mounting portion
34 arm portion
34a through hole
40 lens unit
42 glass lens
44 lens barrel
50 filter unit
52 base member
54 infrared cutting filter (IRCF)
60 sensor board unit (heat source)
62 sensor board
64 image sensor
70 power supply board unit
72 power supply board
76 receptacle connector
80 infrared emission portion (heat source)
82 infrared LED (heat source)
84 flexible printed circuit board (FPC)
90 cable
92 heat conducting plate
922 tip portion
924 terminal end portion
94 heat transfer member
942 heat transfer plate
9422 tip portion
9424 plate part
9426 arm portion
9426a projection portion
9426b cylindrical hole with female thread
944 heat conducting fastening member (heat conducting bolt)
9442 male screw portion
9444 head portion
9444a hexagonal concave portion
AM automobile
AM1 sun visor
AM2 B pillar
AM3 rear glass
AM4 flip down
O optical axis
X fore-and-aft direction (second direction)
Y left-and-right direction (first direction)
Z up-and-down direction

1-13. (canceled)

14. A camera module configured to image a subject, the camera module comprising:
a heat source;
a case configured to hermetically seal the heat source;
a heat conducting plate which is received in an interior of the case and which is configured to come in thermal contact with the heat source;
a heat conducting bracket which is provided at an outside of the case and which is configured to mount the camera module to a mounted body; and
a heat transfer member configured to carry out heat transfer between the heat conducting plate and the heat conducting bracket.

15. The camera module according to claim 14, wherein the heat transfer member comprises:
a heat transfer plate which is received in the interior of the case and which is configured to come in thermal contact with the heat conducting plate; and
a heat conducting fastening member configured to fasten the heat transfer plate and the heat transfer bracket.

16. The camera module according to claim 15, wherein:
the heat transfer plate has a hole provided with a female thread; and
wherein the heat conducting fastening member comprises a heat conducting bolt screwed into the hole.

17. The camera module according to claim 15, wherein each of the heat conducting plate and the heat transfer plate is made of a material having a thermal conductivity not less than 100 W/mK.

18. The camera module according to claim 14, wherein:
the camera module includes a lens unit; and
the heat source comprises a sensor board unit configured to mount an image sensor which is configured to image the subject via the lens unit.

19. The camera module according to claim 18, wherein the heat conducting plate is thermally coupled to the sensor board unit through heat conductive grease.

20. The camera module according to claim 18, wherein the heat source further comprises an infrared light emitting diode (LED) which is disposed in a vicinity of the lens unit.

21. The camera module according to claim 20, wherein the heat conducting plate has a tip portion which comes into contact with a bottom surface of the infrared LED.

22. The camera module according to claim 20, wherein the case comprises:
a first case configured to receive the lens unit, the sensor board unit, the infrared LED, and the heat conducting plate; and
a second case configured to receive the heat transfer plate.

23. The camera module according to claim 22, wherein the first case and the second case are mechanically connected to each other.

24. The camera module according to claim 23, wherein mechanical connection between the first case and the second case is carried out by snap fitting.

25. The camera module according to claim 23, wherein the first case and the second case are made of resin.

26. The camera module according to claim 14, wherein:
the mounted body comprises an inner wall of an automobile; and
the camera module further comprises an on-vehicle camera module which is mounted in a comportment of the automobile.
